(19) United States
(12) Patent Application Publication
(10) Pub. No.: US 2025/0193729 A1
(43) Pub. Date: Jun. 12, 2025

(54) METHOD AND APPARATUS FOR TCP CONGESTION CONTROL IN WIRELESS COMMUNICATION SYSTEM

(71) Applicant: Samsung Electronics Co., Ltd., Suwon-si (KR)

(72) Inventors: Taiho YOON, Suwon-si (KR); Donghoo LEE, Suwon-si (KR); Jongchan CHOI, Suwon-si (KR); Taeho HA, Suwon-si (KR)

(21) Appl. No.: 19/057,664

(22) Filed: Feb. 19, 2025

Related U.S. Application Data
(63) Continuation of application No. PCT/KR2023/012143, filed on Aug. 17, 2023.

(30) Foreign Application Priority Data
Aug. 20, 2022 (KR) 10-2022-0104445
Aug. 22, 2022 (KR) 10-2022-0104897

(51) Int. Cl. H04W 28/02; H04L 5/00

(52) U.S. Cl. CPC H04W 28/0284; H04L 5/0053; H04W 28/0273

(57) ABSTRACT

A method performed by the base station in a wireless communication system according to various embodiments of the present disclosure may comprise: in case that a packet data control protocol (PDCP) service data unit (SDU) is unable to be delivered from a PDCP layer to a lower layer, storing the PDCP SDU in a buffer; in case that the size of the PDCP SDU stored in the buffer is equal to or greater than a preconfigured threshold capacity, including information indicating a TCP congestion situation in a field within the header of a first transmission control protocol (TCP) acknowledgement (ACK) transmitted by a terminal to a server; transmitting, to the server, a second TCP ACK including information indicating the TCP congestion situation; and receiving, from the server, a TCP packet including information indicating that the TCP congestion situation has been identified.

### CROSS-REFERENCE TO RELATED APPLICATIONS

This application is a continuation of International Application No. PCT/KR2023/012143 designating the United States, filed on Aug. 17, 2023, in the Korean Intellectual Property Receiving Office and claiming priority to Korean Patent Application Nos. 10-2022-0104445, filed on Aug. 20, 2022, and 10-2022-0104897, filed on Aug. 22, 2022, in the Korean Intellectual Property Receiving Office, the disclosures of each of which are incorporated by reference herein in their entireties.

### BACKGROUND

### Field

The disclosure relates generally to a wireless communication system and, for example, to a method and a device of a base station for controlling a transmission control protocol (TCP) congestion situation in a wireless communication system.

### Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

A transmission control protocol (TCP) provides a connection-oriented communication service between two applications (e.g., a server and a terminal) connected to a network.

In a TCP connection, a transmission rate of a TCP sender is largely limited by two variable values. A first value is a congestion window (CWND) value, and is used to suppress network congestion when multiple TCP connections exist on the network. The congestion window may also be referred to as a transmission window. The sender may increase or decrease the congestion window value depending on whether the network of the sender is congested, and the congestion window value is a variable managed only internally and is not notified to a counterpart of the TCP connection. A second value is a reception window (RWND) value which has been basically developed to control the transmission rate of the transmission end so as to prevent or reduce a buffer overflow at a reception end, but currently, with the advancement of memory technology, the second value is mainly used to determine a maximum value of a congestion window size so as to control network congestion.

Currently, technologies are being developed to control a TCP congestion situation by configuring fields in a TCP header in order to perform smooth TCP packet transmission and reception between a TCP sender and a TCP receiver in a TCP connection in a wireless communication system.

### SUMMARY

Embodiments of the disclosure provide a device and a method performed by a base station to control a TCP congestion situation in a wireless communication system.

According to various example embodiments of the disclosure, a method performed by a base station in a wireless communication system may include: based on a packet data control protocol (PDCP) service data unit (SDU) being unable to be transferred from a PDCP layer to a lower layer, storing the PDCP SDU in a buffer; based on a size of the PDCP SDU stored in the buffer being equal to or greater than a specified threshold capacity, including information indicating a transmission control protocol (TCP) congestion situation in a field within a header of a first TCP acknowledgement (ACK) transmitted by a terminal to a server; transmitting, to the server, a second TCP ACK including the information indicating the TCP congestion situation; and receiving, from the server, a TCP packet including information indicating that the TCP congestion situation has been confirmed.

According to various example embodiments of the disclosure, a device of a base station in a wireless communication system may include: a communication unit comprising communication circuitry, and at least one processor, comprising processing circuitry, wherein at least one processor, individually and/or collectively, is configured to: based on a packet data control protocol (PDCP) service data unit (SDU) being unable to be transferred from a PDCP layer to a lower layer, store the PDCP SDU in a buffer; based on a size of the PDCP SDU stored in the buffer being equal to or greater than a specified threshold capacity, include information indicating a transmission control protocol (TCP) congestion situation in a field within a header of a first TCP acknowledgement (ACK) transmitted by a terminal to a server; control the device to transmit, to the server, a second TCP ACK including the information indicating the TCP congestion situation; and control the device to receive, from the server, a packet including information indicating that the TCP congestion situation has been confirmed.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example configuration of a communication device and relationships between other devices in a wireless communication system according to various embodiments;

FIG. 2 is a diagram illustrating a hierarchical structure of the wireless communication system according to various embodiments;

FIG. 3 is a diagram illustrating an example indicating a PDCP SDU transferred from a PDCP layer to an RLC layer according to various embodiments;

FIG. 4 is a diagram illustrating an example indicating a PDCP SDU which is unable to be transferred from a PDCP layer to an RLC layer according to various embodiments;

FIG. 5 is a signal flow diagram illustrating an example in which a TCP packet is transmitted and received in the communication system according to various embodiments;

FIG. 6 is a signal flow diagram illustrating an example in which a base station detects a TCP congestion situation in the wireless communication system according to various embodiments;

FIG. 7 is a diagram illustrating an example configuration of a TCP segment according to various embodiments;

FIG. 8 is a diagram illustrating a hierarchical structure in an NR system according to various embodiments;

FIG. 9 is a flowchart illustrating example operations of a base station according to various embodiments;

FIG. 10 is a block diagram illustrating an example configuration of a server in the wireless communication system according to various embodiments;

FIG. 11 is a block diagram illustrating an example configuration of a base station in the wireless communication system according to various embodiments; and

FIG. 12 is a block diagram illustrating an example configuration of a UE in the wireless communication system according to various embodiments.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be apparent, however, that such aspect(s) may be practiced without these specific details.

The terms used in the disclosure are used merely to describe particular embodiments, and may not be intended to limit the scope of various embodiments. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

In the following description, terms referring to signals (e.g., message, signal, signaling, sequence, and stream), terms referring to resources (e.g., symbol, slot, subframe, radio frame (RF), subcarrier, resource element (RE), resource block (RB), bandwidth part (BWP), and occasion), terms for operations (e.g., step, method, process, and procedure), terms referring to data (e.g., information, parameter, variable, value, bit, symbol, and codeword), terms referring to channels, terms referring to control information (e.g., downlink control information (DCI), medium access control codeword element (MAC CE), and radio access control (RRC) signaling), terms referring to network entities, terms referring to device elements, and the like are illustratively used for the sake of convenience. Therefore, the disclosure is not limited by the terms as described below, and other terms referring to subjects having equivalent technical meanings may be used.

A wireless terminal and/or a base station according to various embodiments of the disclosure will be described. A wireless terminal may refer to a device providing voice and/or data connectivity to a user. The wireless terminal may be connected to a computing device such as a laptop computer or desktop computer, or it can be a self-contained device such as a personal digital assistant (PDA). The wireless terminal may also be called a system, a subscriber unit, a subscriber station, mobile station, mobile, remote station, access point, remote terminal, access terminal, user terminal, user agent, user device, or user equipment. The wireless terminal may be a subscriber station, a wireless device, a cellular telephone, a PCS telephone, a cordless telephone, a session initiation protocol (SIP) phone, a wireless local loop (WLL) station, a personal digital assistant (PDA), a handheld device having wireless connection capability, or other processing device connected to a wireless modem. A base station (e.g., access point) may refer to a device in an access network that communicates over the air-interface, through one or more sectors, with wireless terminals. The base station may act as a router between the wireless terminal and the rest of the access network, which can include an Internet Protocol (IP) network, by converting received air-interface frames to IP packets. The base station also coordinates management of attributes for the air interface.

The terms used in the disclosure are used merely to describe various example embodiments, and are not intended to limit the scope of various embodiments. A singular expression may include a plural expression unless they are definitely different in a context. All terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

TCP is one of core protocols of the Internet protocol suite, and is collectively referred to as TCP/IP. TCP provides reliable and ordered delivery of a stream of bytes from a program on a first computer to another program on a second computer. Consequently, TCP is a protocol on which major Internet applications, such as the world wide web, e-mails, and file transfer, reply. For example, TCP provides a point-to-point channel for an application that requires a reliable information communication channel including hypertext transfer protocol (HTTP), file transfer protocol (FTP), and Telnet. TCP is reliable in that TCP guarantees three things to an application layer: (i) a destination will receive data in order of the data being transmitted; (ii) the destination will receive all the data; and (iii) the destination will not receive duplicate data. TCP is bidirectional in that once a connection is established, a server may reply to a client via the same connection. Due to its reliability, TCP dominates wired networks. However, the performance of TCP protocols degrades rapidly as a path delay between two nodes (e.g., between transmission device and a reception device) increases. Reducing a transmission rate can prevent and/or reduce formation or accumulation of unwanted additional congestion. For this reason, TCP performance depends on how quickly feedback information can be returned to the transmission device. For example, a design principle of TCP is to provide feedback to a transmission device in order to reduce a transmission rate when a network is congested. If an uplink autonomous/random bandwidth request or 802.11 data packets are lost due to interference, then bidirectional protocols, such as TCP or RDUP, may significantly slow down. TCP may automatically adjust an available bandwidth by changing a data transmission rate according to the success or failure of transmitted packets. If a TCP-acknowledgment (TCP-ACK) packet which acknowledges a sequence number of received packets is lost, then TCP transmission will slow down or stop until the TCP-ACK is received. Therefore, efficiently providing TCP-ACK is essential to maintain efficient data transmission. For example, according to the TCP standard, a transmission device may react to a packet loss when either three duplicate ACK packets are received or an ACK timeout occurs. In a wired network, a level of congestion may be indicated by a packet loss rate, and an increase in congestion yields an increase in packet loss. However, in a wireless network, a packet loss may be indicated not only by congestion but also by link loss (e.g., distance, interference, etc.). Although a link layer often provides a retransmission mechanism to reduce a link loss rate, which is described in more detail below, the link loss rate is still typically much higher than in a wired network.

Various embodiments of the disclosure provide a device and a method of a base station, by which a TCP congestion situation is controlled in the wireless communication system.

The device and method according to various embodiments of the disclosure may include recognizing a TCP congestion situation without a loss of a PDCP SDU.

In the device and method performed by a base station according to various embodiments of the disclosure, a base station between a server and a UE identifies a communication environment, and induces a quick control of a TCP congestion situation, thereby maintaining a high-quality communication service.

Advantageous effects obtainable from the disclosure may not be limited to the above-mentioned effects, and other effects which are not mentioned may be clearly understood from the following descriptions by those skilled in the art to which the disclosure pertains.

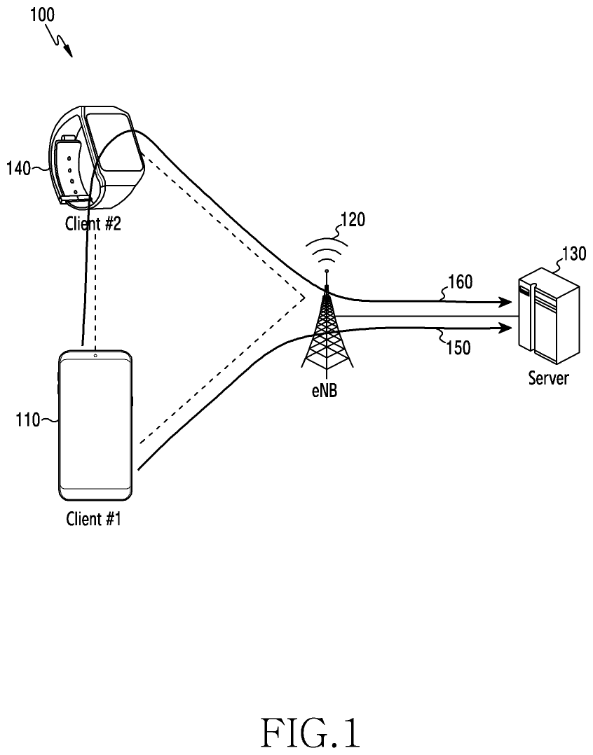

FIG. 1 is a diagram illustrating an example configuration of a communication device and relationships 100 between other devices in a wireless communication system according to various embodiments.

Referring to FIG. 1, a reception device is a device located at the end of a TCP connection, and may refer to a UE 110 or 140 in the disclosure. In addition, a transmission device is a device located at the other end of the TCP connection, and may refer to a server 130 in the disclosure. An intermediate passing-through device is located between the both ends of the TCP connection, which are the UEs 110 and 140 and the server 130, and may be a device that is directly connected to a base station 120 or may be a device that is not directly connected to the base station but is able to identify a situation of a base station uplink resource via communication with a device that is directly connected to the base station. Hereinafter, the intermediate passing-through device may be referred to as a communication device.

TCP connections may be established between the UEs 110 and 140 and the server 130 via the base station 120. The communication device is connected to the base station 120, and may create TCP connections 150 and 160 to the server outside a mobile communication network via the base station 120, and transmit and receive TCP data and TCP ACKs. In addition, the communication device may create the multiple TCP connections 150 and 160 to the multiple UEs 110 and 140, and transmit and receive TCP data and TCP ACKs. Specifically, the base station 120 may transfer TCP data received from the server to the UEs while maintaining the connections to the UE 110 and 140 and the server 130, and transmit TCP ACKs generated by the UEs to the server.

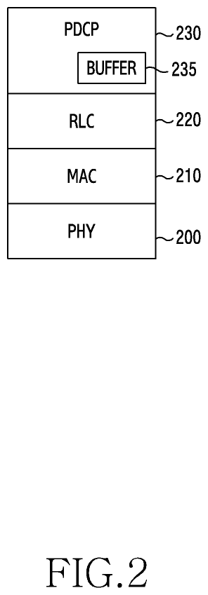

FIG. 2 is a diagram illustrating a hierarchical structure of the wireless communication system according to various embodiments.

Referring to FIG. 2, a layer structure of a transmission end in the wireless communication system according to various embodiments of the disclosure includes a physical (PHY) layer 200, a medium access control (MAC) layer 210, a radio link control (RLC) layer 220, and a packet data convergence protocol (PDCP) layer 230.

The PHY layer 200 provides a data transmission function via a wireless channel, and the MAC layer 210 is a layer responsible for mapping between a logical channel and a transmission channel, and may perform a function of selecting a transmission channel for transmitting data transferred from the RLC layer 220, and adding necessary control information to a header of a MAC PDU. The RLC layer 220 may perform a function for supporting reliable transmission of data. The RLC layer 220 may segment and concatenate RLC service data units (SDUs) transferred from a higher layer in order to configure data of a size corresponding to a wireless section. In addition, a data reassembly function may be supported to restore an original RLC SDU from received RLC PDUs. The RLC layer 220 may operate in one of a transparent mode (TM), an unacknowledged mode (UM), and an acknowledged mode (AM) depending on a processing and transmission scheme of the RLC SDUs. When operating in the TM, the RLC layer 220 may transfer the RLC SDUs received from the higher layer to the MAC layer 210 without adding any header information. In addition, when operating in the UM, the RLC layer 220 does not support data retransmission, and may configure an RLC PDU by segmenting and concatenating RLC SDUs, and in this case, header information including a sequence number may be added to the RLC PDU. When operating in the AM, the RLC layer 220 supports a data retransmission function, and may configure an RLC PDU by segmenting and concatenating RLC SDUs. In this case, for the retransmission function in the AM, various parameters and variables, such as a transmission window, a reception window, a timer, and a counter, may be used.

The PDCP layer 230 is used in a packet exchange area, and may compress and transmit a header of an IP packet so as to improve transmission efficiency of packet data in a wireless channel. In particular, according to an embodiment of the disclosure, the PDCP layer 230 may perform a function for, when an RRC connection to a receiver node is released, temporarily storing a TCP packet existing in a radio bearer in a buffer 235 without discarding (or losing) the same, and then transmitting and receiving the temporarily stored TCP packet when an RRC reconnection is made to the receiver node. Data refers to data that has not been provided from the PDCP layer 230 to another layer, and may be, for example, data that is not transferred from the PDCP layer 230 to the RLC layer 220 or may be a PDCP SDU when data transferred from the PDCP layer 330 is not processed in the RLC layer 340.

The PDCP layer 230 may temporarily store a TCP packet in the buffer 235 or may discard the TCP packet without temporarily storing in the buffer 235 according to a size of the TCP packet or the number of TCP packets. The PDCP layer 230 may measure TCP session information for a TCP packet and a point in time when an RRC connection is released, and map TCP packets corresponding to respective TCP sessions to TCP session information and timestamp values indicating points in time when an RRC connection is released, thereby storing the same. In this case, the TCP session information may be referred to as 5 tuple information in another term, and may include a source IP address, a source port, a destination IP address, a destination port, and protocol information. For example, the PDCP layer 230 may identify TCP session information of a TCP packet and a timestamp value, and map the identified TCP session information and timestamp value to each TCP packet, thereby storing the same. In addition, when an RRC reconnection is detected, the PDCP layer 230 detects a TCP session corresponding to TCP session information of a TCP packet temporarily stored in the buffer 235, and controls and processes a function for transmitting the TCP packet via the detected TCP session. In addition, when there exist TCP packets stored in the buffer 235 for a threshold time or longer, the PDCP layer 230 controls and processes a function for discarding the TCP packets. In this case, the PDCP layer 230 may determine whether the TCP packets have been stored for the threshold time or longer, using timestamp values mapped to the respective TCP packets and stored. Here, discarding of the TCP packets stored for the threshold time or longer is to prevent and/or reduce the TCP packets from being continuously accumulated in the buffer 235. In this case, the buffer 235 may distinguish and store TCP packets according to TCP sessions, in which case, the buffer 235 may be a pool buffer.

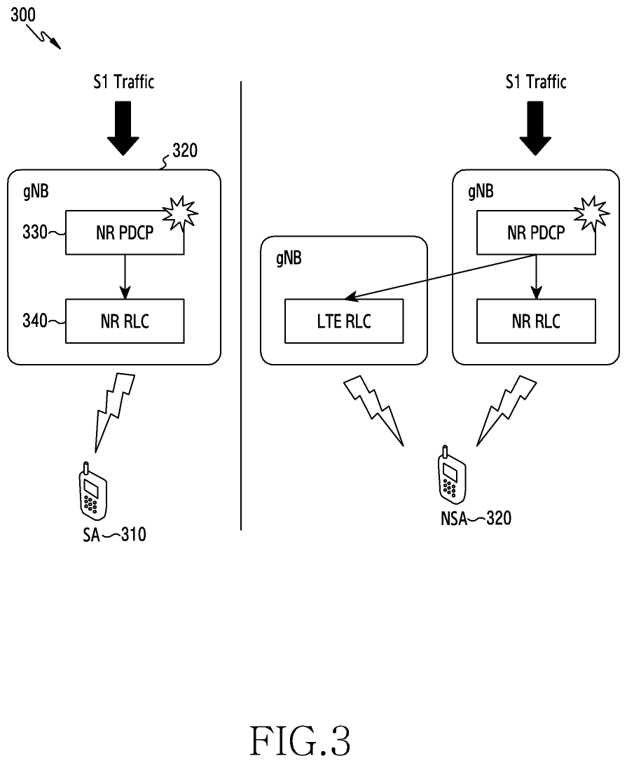

FIG. 3 is a diagram illustrating an example 300 indicating a PDCP SDU transferred from a PDCP layer to an RLC layer according to various embodiments.

Referring to FIG. 3, in an NR system, a form of a wireless communication service may have a stand-alone (SA) structure 310 and a non-stand-alone (NSA) structure 320. A PDCP layer (e.g., the PDCP layer 230 of FIG. 2) may transfer data from an NR PDCP layer 330 to an NR RLC layer 340 in the SA structure 310, and may transfer data to an LTE RLC layer and an NR RLC layer in the NSA structure 320. In the wireless communication service system with the form of the SA structure 310, if the NR RLC layer 340 is unable to receive data due to an excess of data receivable from the NR PDCP layer 330, no data may be transferable. For example, if data, which exceeds an amount of data receivable by the NR RLC layer 340 during a certain time interval, is transferred from the NR PDCP layer 330, or if data received from the NR PDCP layer 330 is not processed in the NR RLC layer 340, data may not be transferable from the NR PDCP layer 330 to the NR RLC layer 340.

According to an embodiment of the disclosure, data that has failed to be transferred from the NR PDCP layer 330 to the NR RLC layer 340 may be stored in a buffer existing in the NR PDCP layer 330. Data stored in the buffer refers to data that has not been transferred from the NR PDCP layer 330 to a lower layer, and may be, for example, a PDCP SDU that is not transferred from the NR PDCP layer 330 to the NR RLC layer 340.

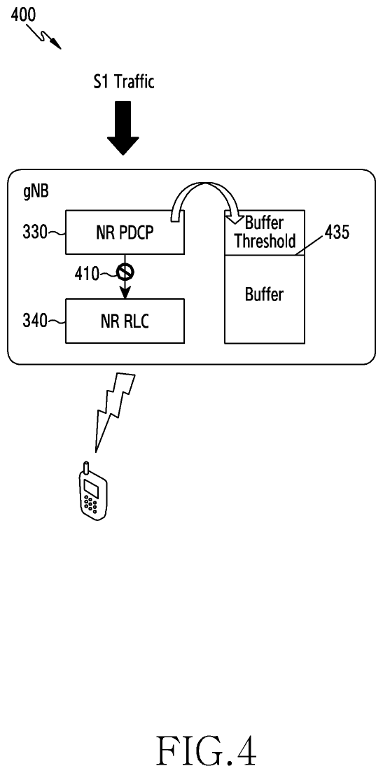

According to an embodiment of the disclosure, if the NR RLC layer 340 is unable to receive a PDCP SDU from the NR PDCP layer 330, the NR PDCP layer 330 may store, in the buffer within the NR PDCP layer 330, the PDCP SDU that has failed to be transferred to the NR RLC layer 340. This will be described in more detail below with reference to FIG. 4.

FIG. 4 is a diagram illustrating an example 400 indicating a PDCP SDU which is unable to be transferred from a PDCP layer to an RLC layer according to various embodiments.

Referring to FIG. 4, in the NR system, there may be a case 410 where data cannot be transferred from the NR PDCP layer 330 to the NR RLC layer 340. For example, if data, which exceeds the amount of data receivable by the NR RLC layer 340 during a certain time interval, is transferred from the NR PDCP layer 330, or if data received from the NR PDCP layer 330 is not processed in the NR RLC layer 340, data may not be transferable from the NR PDCP layer 330 to the NR RLC layer 340. In this case, the data that has failed to be transferred may be a PDCP SDU.

According to an embodiment of the disclosure, in a case 410 where data cannot be transferred to the NR RLC layer 340, the data that has failed to be transferred may be stored in the buffer 235 existing in the NR PDCP layer 330. That is, the NR PDCP layer 330 may temporarily store a transmission control protocol (TCP) packet in the buffer 235 without discarding (or losing) the same.

According to an embodiment of the disclosure, if a size of the data stored in the buffer 235 in the NR PDCP layer 330 is equal to or greater than a preconfigured threshold capacity 435 of the buffer 235, a base station may recognize a TCP congestion situation in which TCP packets cannot be smoothly transferred.

According to an embodiment of the disclosure, if data stored in the buffer 235 in the NR PDCP layer 330, for example, a TCP packet, has a size equal to or greater than the preconfigured threshold capacity 435 of the buffer 235, the base station may include information indicating a TCP congestion situation in a field within a header of a TCP acknowledgement (ACK) transmitted from a UE to a server. According to the operation of the base station, the TCP ACK including the information indicating the TCP congestion situation may be transferred to the server. The information indicating the TCP congestion situation may be included in a TCP ECN-echo (ECE) field inducing a TCP congestion situation control. For example, the base station may include information, which indicates that the ECN-echo (ECE) field inducing the TCP congestion situation control has been configured, in a field within a header of a first TCP ACK transferred from the UE to the server, where the size of the PDCP SDU stored in the buffer 235 is preconfigured, and the base station may transmit a second TCP ACK including the information to the server. Configuring of the field includes changing a value of the field or configuring the value of the field to be 0 or 1.

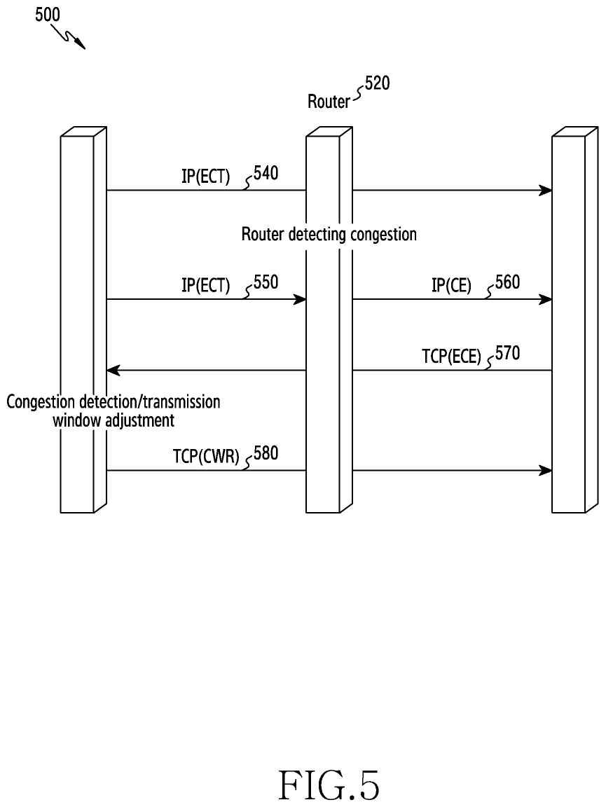

FIG. 5 is a signal flow diagram illustrating an example 500 in which a TCP packet is transmitted and received in the communication system according to various embodiments.

Referring to FIG. 5, when a TCP sender and a TCP receiver exchange data in a TCP connected state, a router 520 that is a network device may read and analyze an IP header or a TCP header. The router 520 selects a predetermined process and identifies an explicit congestion notification (ECN) field of an IP header of a corresponding packet, and if an ECN field value is 01 or 10, an ECN-capable transport (ECT) and a congestion experience (CE) may be configured to notify a receiver that congestion has occurred. For example, the router 520 may identify ECT 540 and 550 configurations of IP headers of packets from a sender to a receiver, and configure a CE 560 for an IP header so as to notify the receiver that congestion has occurred.

According to an embodiment of the disclosure, the receiver having recognized the occurrence of congestion may configure an ECN-echo (ECE) 570 field within a TCP header of an uplink packet (e.g., TCP ACK) corresponding to the received packets in which the ECTs 540 and 550 and the CE 560 are configured, and may notify the sender that congestion has occurred.

The sender that has received, from the receiver, the TCP ACK in which the ECE field is configured may recognize the occurrence of congestion, and reduce a size of a congestion window (or a transmission window) so as to lower a transmission rate of data being transmitted.

According to an embodiment of the disclosure, in order to notify the receiver that the transmission rate of data has been lowered and the ECE field configuration has been properly received, the sender having reduced the size of the congestion window may configure a congestion window reduced (CWR) 580 within a TCP header of a packet transmitted to the receiver, and transmit the packet.

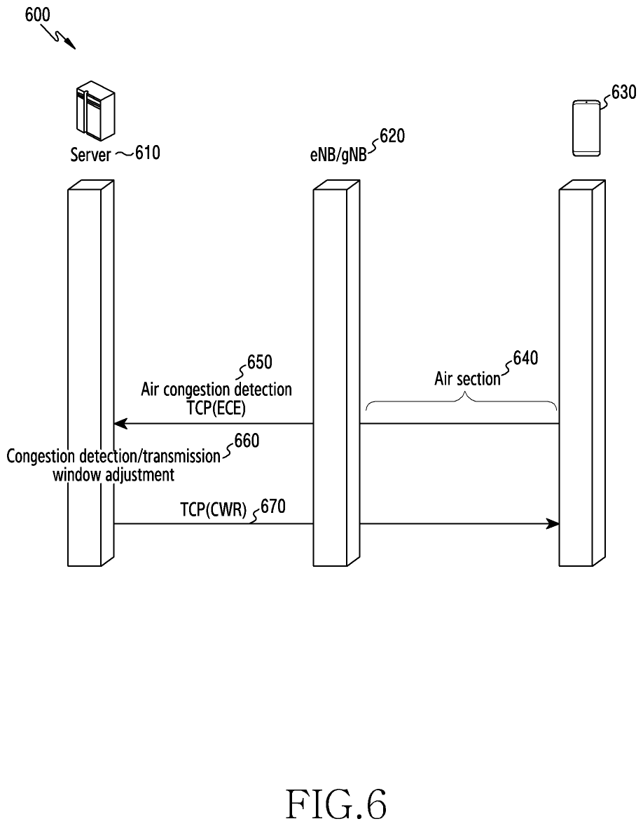

The operations for controlling the congestion situation in FIG. 5 describe congestion situation control operations of the sender and the receiver in a situation where wired connections are made between the UE and the router and between the router and the server. When the congestion situation control operations are applied to a wireless system, it may be difficult to recognize a congestion situation via wireless communication between the UE and the router. In other words, it may be difficult for the server, which transmits data, to recognize a congestion situation in a wireless section between the UE and the router. The sender in the wireless system is unable to quickly recognize and control a congestion situation compared to a situation where a wired connection is made, so that there may be a problem that a quality of the wireless communication system may deteriorate. Accordingly, hereinafter, operations of a base station for controlling a TCP congestion situation in the wireless communication system are described in more detail in FIG. 6.

FIG. 6 is a signal flow diagram illustrating an example 600 in which a base station detects a TCP congestion situation in the wireless communication system according to various embodiments.

A base station may serve to relay communication between a UE and a server. For example, the base station may serve to transfer a TCP packet that the UE transmits to the server, and to transfer a TCP packet that the server transmits to the UE.

Referring to FIG. 6, the base station 620 may serve to relay communication between the UE 630 and the server 610, and may identify a communication state of data that the UE 630 transmits to the server 610. For example, the base station 620 may identify a communication state of data in an air section 640 which is a wireless communication section between the UE 630 and the base station 620.

According to an embodiment of the disclosure, in order to identify the communication state of the data in the air section 640, the base station 620 may determine whether a size of a PDCP SDU, which has failed to be transferred from a PDCP layer (e.g., the PDCP layer 330 of FIG. 3) to an RLC layer (e.g., the RLC layer 340 of FIG. 3) and stored in a buffer (e.g., the buffer 235 of FIG. 2), is equal to or greater than a threshold capacity (e.g., the threshold capacity 435 of FIG. 4) of the buffer.

According to an embodiment of the disclosure, if the size of the PDCP SDU stored in the buffer of the PDCP layer is equal to or greater than the threshold capacity of the buffer, the base station 620 may recognize that there is a congestion situation in which data cannot be transferred from the PDCP layer to the RLC layer or data is not being processed quickly in the RLC layer. When the base station 620 recognizes 650 the TCP congestion situation, information indicating the TCP congestion situation may be included in data transmitted from the UE 630 to the server 610. For example, the base station 620 may include the information indicating the TCP congestion situation in a field within a header of a TCP acknowledgement (ACK) transmitted from the UE 630 to the server 610. According to the operation of the base station, the TCP ACK including the information indicating the TCP congestion situation may be transferred to the server. The information indicating the TCP congestion situation may be included in a TCP ECN-echo (ECE) field inducing a TCP congestion situation control. For example, the base station may include information, which indicates that the ECN-echo (ECE) field inducing the TCP congestion situation control has been configured, in a field within a header of a first TCP ACK transferred from the UE to the server, and may transmit a second TCP ACK including the information to the server. Configuring of the field includes changing a value of the field or configuring the value of the field to be 0 or 1.

According to an embodiment of the disclosure, the procedure in which the base station 620 transmits the second TCP ACK to the server 610 may be maintained until the server 610 configures 670 a congestion window reduced (CWR) in a TCP packet transmitted to the base station 620, and transmits the TCP packet to the base station. That is, if the CWR is configured 670 in the TCP packet received from the server 610, and the CWR is configured in the same TCP flow flowing in a radio bearer of the PDCP layer of the base station 620, the base station 620 may stop the operation of transmitting the second TCP ACK including the information indicating that the ECE field has been configured.

According to an embodiment of the disclosure, the server 610 having received the data including the information indicating the TCP congestion situation from the base station 620 may recognize the congestion situation based on the information indicating the TCP congestion situation. In addition, the server 610 may adjust 660 a size of a transmission window (or congestion window) of the server 610 side data. For example, the server 610 having received the second TCP ACK, which includes the configuration of the ECE field inducing the TCP congestion situation control in the field within the header of the first TCP ACK transmitted by the UE to the server, may recognize the TCP congestion situation and adjust the size of the transmission window of the server 610 side data. By adjusting the size of the transmission window, the server 610 may eliminate a transmission delay time and a processing delay time in the network so as to reduce a duration of the TCP congestion situation, and enable a quick response to the traffic congestion in the network, thereby stabilizing the network.

According to an embodiment of the disclosure, the server 610 having adjusted the size of the congestion window may configure a CWR field, which indicates that the size of the transmission window has been adjusted, in the TCP packet transmitted to the UE 630 via base station 620. A TCP header of the TCP packet transmitted by the server 610 to UE 630 may include the configured CWR field.

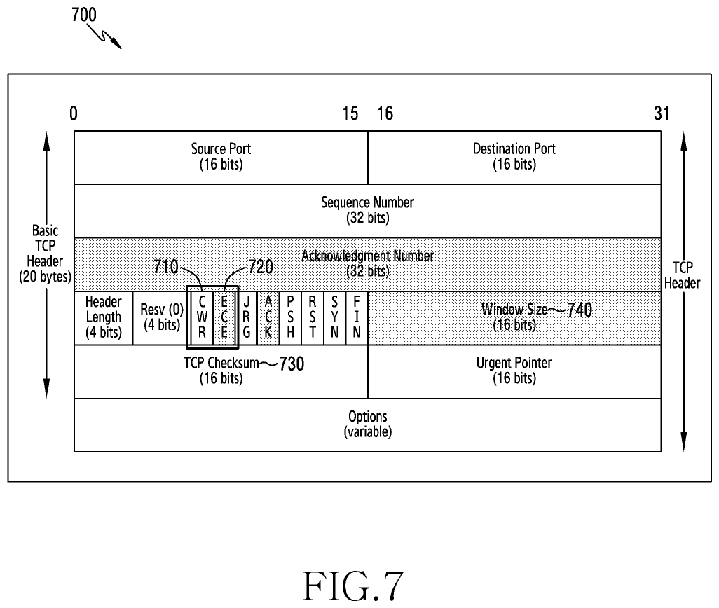

FIG. 7 is a diagram illustrating an example configuration of a TCP segment 700 according to various embodiments. FIG. 7 illustrates a typical 32-bit TCP segment structure. A TCP segment includes a destination port (16 bits) that identifies a reception port as well as a source port (16 bits) that identifies a transmission port.

Referring to FIG. 7, the TCP segment 700 may include a sequence number. For example, if a synchronize sequence number (SYN) flag is set (1), this is an initial sequence number. A sequence number of an actual first data byte and an ACK number in a corresponding ACK are obtained by adding 1 to this sequence number. However, if the SYN flag is clear (0), this is an accumulated sequence number of the first data byte of a packet for a current session. However, if the SYN flag is clear (0), this is an accumulated sequence number of the first data byte of a packet for a current session. Regarding the ACK number (32 bits), if an ACK flag is set, then a value of an ACK number field is a subsequent sequence number that a receiver is expecting (this acknowledges reception of all previous bytes, if any). A first ACK transmitted by each end acknowledges an initial sequence number itself of the other end, except for no data. A data offset (4 bits) specifies a size of the TCP header in 32-bit words. A minimum size header is 5 words, and a maximum is 15 words, so that a minimum of 20 bytes and a maximum of 60 bytes are provided, and up to 40 bytes of an option is allowed in the header. This field also derives its name from the fact that it is an offset from the start of the TCP segment to the actual data. A reserved field (4 bits) is designated for future use and should be currently configured to be 0.

The TCP segment further includes the following eight 1-bit flags (a total of 8 bits): (i) a congestion window reduced (CWR) flag 710 that is configured by a transmission host to indicate that a TCP segment with an ECN-echo (ECE) flag set 720 has been received, and that a response has been made to congestion control mechanism; (ii) an ECE flag 720 to indicate (a) if a synchronize sequence number (SYN) flag is set (1), that a TCP peer is explicit congestion notification (ECN) capable, and (b) if the SYN flag is clear (0), that a packet with a congestion experienced (CE) flag in an IP header set has been received during normal transmission (added to a header by RFC 3168); (iii) an URG flag to indicate that an urgent pointer field is significant; (iv) an ACK flag to indicate that an acknowledgment field is significant (all packets after a client transmits an initial SYN packet should have this flag set); (v) a push function (PSH) flag that requests to push buffered data to an reception application; (vi) an RST flag that resets a connection; (vii) a SYN flag—only a first packet transmitted from each end should have this flag set (some other flags change their meaning according to this flag, some are valid only when it is set, and others are valid only when it is clear); and (viii) a FIN flag to indicate that there is no more data from a transmitter. A window size (16 bits) 740 represents a size of a reception window, and specifies the number of bytes (equal to or greater than the sequence number in the acknowledgment field) that the receiver is currently willing to receive (see flow control and window scaling below). Checksum (16 bits) 730 may be used for error-checking of the header and data. If the URG flag is set, an urgent pointer (16 bits) may indicate this 16-bit field is an offset from a sequence number indicating the last urgent data byte. Options are variable 0-320 bits divisible by 32. A length of an option field is determined by a data offset field. Options 0 and 1 are a single byte (8 bits) in length. The remaining options indicate a total length of the option (expressed in bytes) in a second byte. TCP header padding is used to ensure that the TCP header ends and data begins on a 32-bit boundary, and includes only zeros.

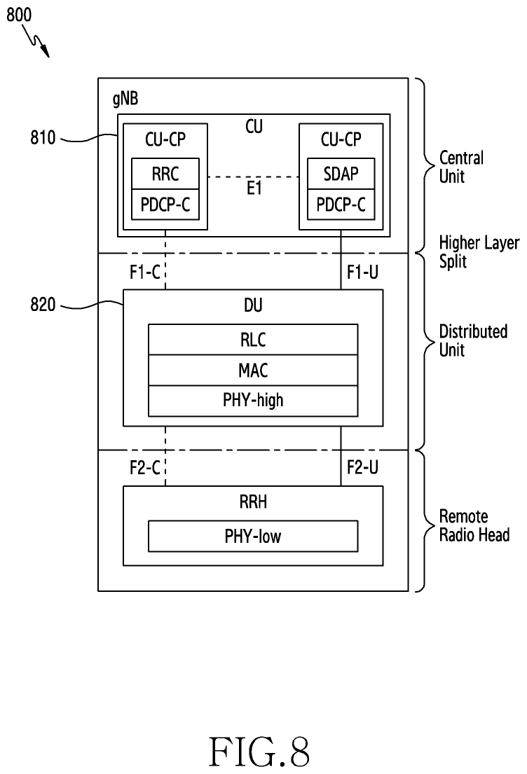

FIG. 8 is a diagram illustrating a hierarchical structure in the NR system according to various embodiments.

The NR system may reconfigure a gNB 800 into two logical network elements of a central unit (CU) 810 and a distributed unit (DU) 820 by introducing a function split technique for separating the CU 810 and the DU 820 in terms of transmission capacity, transmission delay, and facilitation of deployment. A CU control plane, e.g., a CU-CP, communicates with the DU 820 using an F1-C interface, and a CU user plane, e.g., a CU-UP, communicates with the DU 820 using an F1-U interface. In addition, the CU-CP and the CU-UP communicate using an E1 interface.

Referring to FIG. 8, the CU-CP may be configured to include an RRC layer and a PDCP layer, and the CU-CP may be configured to include an SDAP layer and a PDCP layer. The DU 820 may be configured to include an RLC layer, a MAC layer, and a PHY layer. FIG. 8 illustrates an example of a function split structure, and is not limited thereto, and various function split structures may be provided depending on which functions or layers are included in the CU 810 and the DU 820.

According to an embodiment of the disclosure, if an amount of data transmitted from the CU 810 to the DU 820 exceeds an amount that the DU 820 is able to receive, or if data received by the DU 820 from the CU 810 is not processed, the CU 810 may not transmit data to the DU 820. For example, if the PDCP layer of the CU-CP attempts to transfer data exceeding the amount of data that the RLC layer of the DU 820 is able to receive, the CU 810 may not be able to transfer data to the DU 820. In this case, the data may be a PDCP SDU.

According to an embodiment of the disclosure, when data cannot be transferred from the CU 810 to the DU 820, the CU 810 may temporarily store the data failed to be transferred in a buffer within the PDCP layer. That is, when data cannot be transferred from the CU 810 to the DU 820, the data may be stored in the buffer without being discarded (or lost) in the PDCP layer of the CU 810.

According to an embodiment of the disclosure, if a size of the data stored in the buffer in the PDCP layer of the CU 810 is equal to or greater than a preconfigured threshold capacity (e.g., the threshold capacity 435 of FIG. 4) of the buffer, the gNB 800 may recognize that there is a TCP congestion situation in which TCP packets cannot be smoothly transferred.

According to an embodiment of the disclosure, the gNB 800 may include information indicating the TCP congestion situation in a field within a header of a TCP acknowledgement (ACK) transmitted from a UE to a server. According to the operation of the gNB 800, the TCP ACK including the information indicating the TCP congestion situation may be transferred to the server. The information indicating the TCP congestion situation may be included in a TCP ECN-echo (ECE) field inducing a TCP congestion situation control. For example, the gNB 800 may include information, which indicates that the ECN-echo (ECE) field inducing the TCP congestion situation control has been configured, in a field within a header of a first TCP ACK transferred from the UE to the server, where the size of the PDCP SDU stored in the buffer is preconfigured, and the gNB 800 may transmit, to the server, a second TCP ACK which includes the configuration of the ECE field inducing the TCP congestion situation control in the field within the header of the first TCP ACK. Configuring of the field includes changing a value of the field or configuring the value of the field to be 0 or 1.

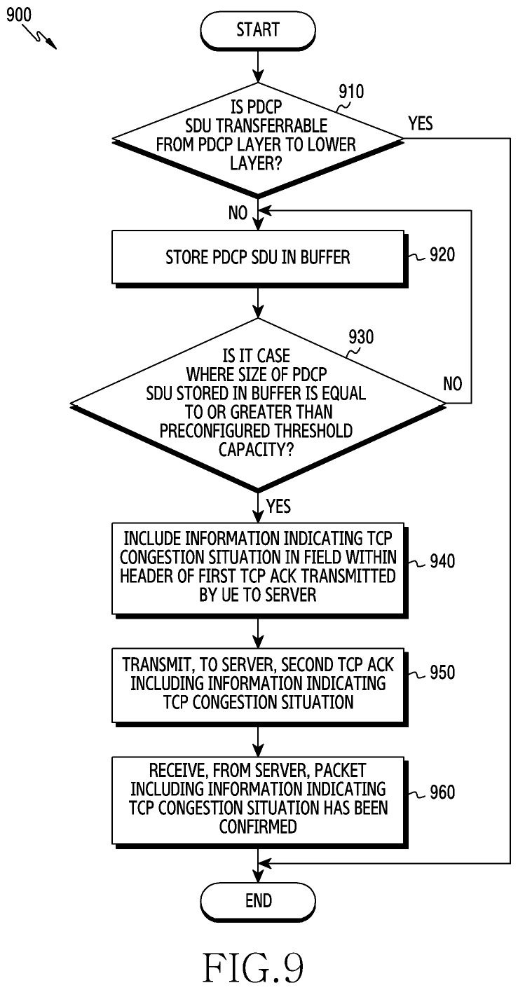

FIG. 9 is a flowchart illustrating example operations 900 of a base station according to various embodiments.

Referring to FIG. 9, in operation 910, a base station (e.g., the base station 120 of FIG. 1) may determine whether a PDCP SDU is transferable from a PDCP layer (e.g., the PDCP layer 330 of FIG. 3) to a lower layer (e.g., the RLC layer 340 of FIG. 3). If the PDCP SDU cannot be transferred from the PDCP layer to the RLC layer, operation 920 may be performed.

In operation 920, the base station may store the PDCP SDU, which cannot be transferred from the PDCP layer to the RLCL layer, in a buffer (e.g., the buffer 235 of FIG. 4) within the PDCP. According to an embodiment of the disclosure, the PDCP SDU existing in a radio bearer stored in the buffer may include a transmission control protocol (TCP) packet, and the TCP packet may be temporarily stored in the buffer 235 without being discarded (or lost).

In operation 930, the base station may determine whether the PDCP SDU stored in the buffer within the PDCP layer has a size equal to or greater than a preconfigured (e.g., specified) threshold capacity of the buffer. If the size of the PDCP SDU stored in the buffer is equal to or greater than the threshold capacity of the buffer, the base station performs operation 940, and if the size of the PDCP SDU is smaller than the threshold capacity of the buffer, the base station may continue storing, in the buffer, PDCP SDUs that cannot be transmitted from the PDCP layer to the RLC layer.

In operation 940, if the size of the PDCP SDU stored in the buffer is equal to or greater than the threshold capacity of the buffer, the base station may recognize that there is a congestion situation in which data cannot be transferred from the PDCP layer to the RLC layer or data is not being processed quickly in the RLC layer. For example, the base station may identify a communication state of data in an air section (e.g., the air section 640 of FIG. 6) which is a communication section between the base station and a UE.

According to an embodiment of the disclosure, when recognizing the congestion situation of TCP packet, the base station may include information indicating the TCP congestion situation in a TCP packet transmitted from the UE to a server. The base station may include the information indicating the TCP congestion situation in a field within a header of a first TCP acknowledgement (ACK) transmitted from the UE to the server. For example, the base station may transfer, to the server, a second TCP ACK which includes an ECN-echo (ECE) field inducing a TCP congestion situation control in the field within the header of the first TCP ACK transferred from the UE to the server, where the size of the PDCP SDU stored in the buffer is preconfigured. The information indicating the TCP congestion situation may be included in the TCP ECN-echo (ECE) field inducing the TCP congestion situation control within a header of the second TCP ACK.

According to an embodiment of the disclosure, when the information indicating the TCP congestion situation is included in the field within the first TCP ACK, a TCP checksum value may be recalculated based on the information indicating the TCP congestion situation.

In operation 950, the base station may transfer, to the server, the second TCP ACK which includes the configuration of the ECE field inducing the TCP congestion situation control in the field within the header of the first TCP ACK. For example, the second TCP ACK may include, in the field within the TCP header, the information indicating that the ECE field has been configured.

According to an embodiment of the disclosure, the server having received the data including the information indicating the TCP congestion situation from the base station may recognize the congestion situation. In addition, the server may adjust a size of a transmission window of server-side data. For example, the server having received the second TCP ACK, which includes the configuration of the ECE field inducing the TCP congestion situation control in the field within the header of the first TCP ACK, may recognize the TCP congestion situation and adjust the size of the transmission window of the server-side data.

In operation 960, the base station may receive, from the server, a packet including information indicating that the TCP congestion situation has been confirmed. The packet received by the base station from the server may include a TCP packet.

According to an embodiment of the disclosure, the information indicating that the TCP congestion situation has been confirmed may be included in a CWR field, which indicates that the size of the transmission window has been adjusted, within the TCP header of the TCP packet transmitted to the UE via the base station by the server having adjusted the size of the congestion window.

According to an embodiment of the disclosure, based on the CWR field within the TCP header of the TCP packet transmitted from the server to the UE, the base station may stop the operations of the base station, which are operations 940 and 950 of including the information indicating the TCP congestion situation in the field within the header of the first TCP ACK. That is, if the base station identifies configuration information of the CWR field of the TCP packet transmitted to the UE by the server, and the CWR is configured in the same TCP flow flowing in a radio bearer of the PDCP layer, the operations may be stopped. That is, the base station having identified the CWR field configuration within the header of the TCP packet from the server may stop the operation of transferring, to the server, the second TCP ACK in which the ECE field has been configured in the first TCP ACK transferred from the UE to the server.

However, the operations of the base station and the order of the operations are not limited to the example described above.

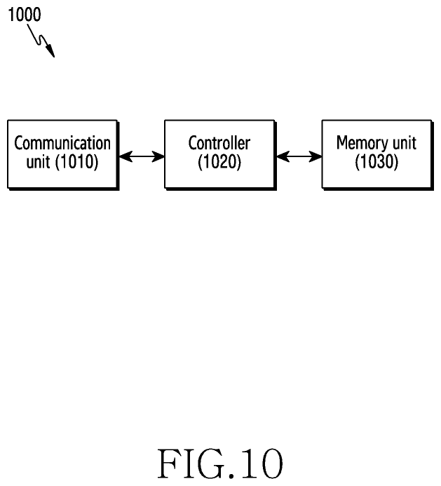

FIG. 10 is a block diagram illustrating an example configuration of a server 1000 in the wireless communication system according to various embodiments. The server 1000 includes a communication unit (e.g., including communication circuitry) 1010, a controller (e.g., including control/processing circuitry) 1020, and a memory unit (e.g., including a memory) 1030.

The terms “ . . . unit”, “ . . . device”, etc. used hereinafter may refer to a unit configured to process at least one function or operation, and may be implemented as hardware, software, or a combination of hardware and software.

Referring to FIG. 10, a communication unit 1010 may include various communication circuitry and provide an interface configured to enable communication with other nodes within a network. For example, the communication unit 1010 may convert, into physical signals, bit strings transmitted from the server 1000 to other nodes, for example, a base station and a core network, and may convert physical signals received from the other nodes into bit strings.

The communication unit 1010 according to various embodiments of the disclosure may transmit a response message to a base station according to a period determined for transmitting the response message, based on at least one of information on data from a UE, which is transferred via the base station, and information on whether a TCP congestion situation occurs.

The memory unit 1030 may include a memory and store data, such as basic programs, application programs, and configuration information for operations of the server 1000. The memory unit 1030 provides stored data in response to a request of the controller 1020.

According to various embodiments of the disclosure, the memory unit 1030 may store a response message including at least one of information on data from a UE, which is transferred via a base station, and information on whether a TCP congestion situation occurs.

The controller 1020 may include various processing/control circuitry and control overall operations of the server 1000. For example, the controller 1020 may transmit and receive signals via the communication unit 1010. In addition, the controller 1020 may record and read data in the storage unit 1030. To this end, the controller 1020 may include at least one processor. At least one processor of the controller 1020 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to various embodiments of the disclosure, the controller 1020 may determine a period for transmitting a response message, based on at least one of information on data from a UE, which is transferred via a base station, and information on whether a TCP congestion situation occurs.

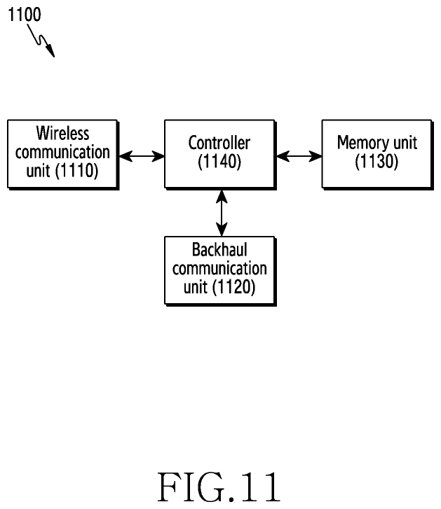

FIG. 11 is a block diagram illustrating an example configuration of a base station 1100 in the wireless communication system according to various embodiments.

The terms “ . . . unit”, “ . . . device”, etc. used hereinafter may refer to a unit configured to process at least one function or operation, and may be implemented as hardware, software, or a combination of hardware and software.

Referring to FIG. 11, the base station 1100 includes a wireless communication unit (e.g., including communication circuitry) 1110, a backhaul communication unit (e.g., including communication circuitry) 1120, a memory unit (e.g., including a memory) 1130, and a controller (e.g., including control/processing circuitry) 1140.

The wireless communication unit 1110 may include various communication circuitry including an RF processor (not illustrated) and a baseband processor (not illustrated). The RF processor (not illustrated) may perform functions for signal transmission and reception via a wireless channel, such as signal band transform and amplification. That is, the RF processor (not illustrated) up-converts a baseband signal provided from the baseband processor (not illustrated) into an RF band signal and then transmits the converted RF band signal through an antenna, and down-converts an RF band signal received through the antenna into a baseband signal. For example, the RF processor (not illustrated) may include a transmission filter, a reception filter, an amplifier, a mixer, an oscillator, a DAC, an ADC, and the like. The base station 1100 may include multiple antennas. In addition, the RF processor (not illustrated) may include multiple RF chains. Furthermore, the RF processor (not illustrated) may perform beamforming. For beamforming, the RF processor (not illustrated) may adjust a phase and a magnitude of each of signals transmitted and received through the multiple antennas or antenna elements.

In addition, the wireless communication unit 1110 may transmit and receive signals. To this end, the wireless communication unit 1110 may include at least one transceiver. The wireless communication unit 1110 may receive a downlink signal. The downlink signal may include a synchronization signal (SS), a reference signal (RS) (e.g., cell-specific reference signal (CRS)), a demodulation (DM)-RS, system information (e.g., MIB, SIB, remaining system information (RMSI), and other system information (OSI)), a configuration message, control information, downlink data, or the like. In addition, the communication unit 1801 may transmit an uplink signal. The uplink signal may include a random access-related signal (e.g., a random-access preamble (RAP) (or message 1 (Msg1) and message 3 (Msg3)), a reference signal (e.g., a sounding reference signal (SRS) and a DM-RS), a power headroom report (PHR), or the like.

In addition, the wireless communication unit 1110 may include different communication modules to process signals of different frequency bands.

Furthermore, the wireless communication unit 1110 may include multiple communication modules to support multiple different radio access technologies. For example, different radio access technologies may include Bluetooth low energy (BLE), wireless fidelity (Wi-Fi), Wi-Fi gigabyte (WiGig), cellular networks (e.g., long-term evolution (LTE)), new radio (NR), and the like. In addition, different frequency bands may include super high frequency (SHF) (e.g., 2.5 Ghz and 5 Ghz) bands and millimeter (mm) wave (e.g., 38 GHz, 60 GHz, etc.) bands. In addition, the communication unit 1310 may use a radio-access technology of the same scheme on different frequency bands (e.g., an unlicensed band for licensed assisted access (LAA) and a citizen broadband radio service (CBRS) (e.g., 3.5 GHZ)).

The wireless communication unit 1110 may transmit and receive signals as described above. Accordingly, all or a part of the wireless communication unit 1110 may be referred to as “transmitter”, “receiver”, or “transceiver”. In addition, in the following description, transmission and reception performed via a wireless channel are used in a sense including processing performed as described above by the wireless communication unit 1110.

According to various embodiments of the disclosure, the baseband processor (not illustrated) may perform a function of conversion between a baseband signal and a bit string according to physical layer specifications of the system. For example, during data transmission, the baseband processor (not illustrated) generates complex symbols by encoding and modulating a transmission bit string. In addition, during data reception, the baseband processor (not illustrated) reconstructs a reception bit string via demodulation and decoding of a baseband signal provided from the RF processor (not illustrated). For example, when conforming to an OFDM scheme, during data transmission, the baseband processor (not illustrated) generates complex symbols by encoding and modulating a transmission bit string, maps the complex symbols to sub-carriers, and then configures OFDM symbols by performing IFFT operation and CP insertion. In addition, during data reception, the baseband processor (not illustrated) divides a baseband signal provided from the RF processor (not illustrated) in units of OFDM symbols, reconstructs signals mapped to sub-carriers via an FFT operation, and then reconstructs a reception bit string via demodulation and decoding. The baseband processor (not illustrated) and the RF processor (not illustrated) transmit and receive signals as described above. Accordingly, the baseband processor (not illustrated) and the RF processor (not illustrated) may be referred to as a transmitter, a receiver, and a transceiver, or a communication unit.

The wireless communication unit 1110 according to various embodiments of the disclosure may receive data from a UE. In addition, the wireless communication unit 1110 may transfer, to the UE, a response message that a server has transmitted to the UE.

The backhaul communication unit 1120 may include various communication circuitry and provide an interface configured to enable communication with other nodes within a network. That is, the backhaul communication unit 1120 may convert, into physical signals, bit strings transmitted from the base station 1100 to other nodes, for example, another base station and a core network, and may convert physical signals received from the other nodes into bit strings.

The backhaul communication unit 1120 according to various embodiments of the disclosure may receive, from the server, a response message that the server transmits to a UE.

The memory unit 1130 may include a memory and store data, such as basic programs, application programs, and configuration information for operations of the base station 1100. The memory unit 1130 may provide stored data in response to a request of the controller 1140.

The controller 1140 may include various control/processing circuitry and control overall operations of the base station 1100. For example, the controller 1140 transmits and receives signals via the wireless communication unit 1110 or the backhaul communication unit 1120. In addition, the controller 1140 may record and read data in the memory unit 1130. To this end, the controller 1140 may include at least one processor. At least one processor of the controller 1140 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

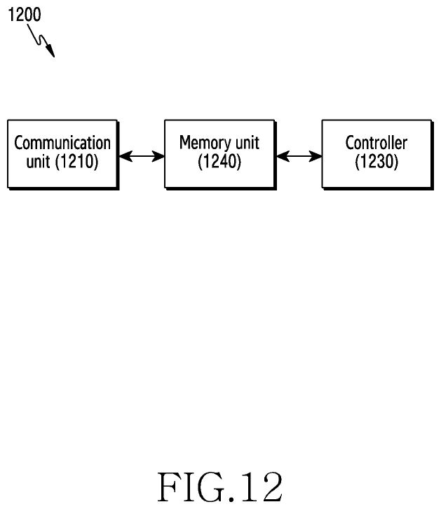

FIG. 12 is a block diagram illustrating an example configuration of a UE 1200 in the wireless communication system according to various embodiments.

The terms “-unit”, “-device”, etc. used hereinafter refer to a unit that processes at least one function or operation, which may be implemented by hardware or software, or a combination of hardware and software.

Referring to FIG. 12, a UE 1200 may include a communication unit (e.g., including communication circuitry) 1210, a memory unit (e.g., including a memory) 1230, and a controller (e.g., including control/processing circuitry) 1240.

The communication unit 1210 may include various communication circuitry and perform a function of transmitting and receiving wireless signals of data input and output through an antenna. For example, in a case of transmission, a function of channel coding data to be transmitted, and then RF processing and transmitting the data may be performed, and in a case of reception, a function of converting a received RF signal into a baseband signal, and channel decoding the baseband signal to restore data may be performed.

The communication unit 1210 according to various embodiments of the disclosure may transmit data to and receive data from a base station via each of multiple transmission control protocol connections. The communication unit 1210 may include a first communication module for communication with a mobile communication network, and a second communication module for communication with a wireless LAN.

The memory unit 1230 may include a memory and store various reference data and micro codes of programs for processing and controlling the controller 1240.

The memory unit 1230 according to various embodiments of the disclosure may store network information including information on at least one of a measured buffer size, a buffer state report, a modulation and encoding scheme, an allocated resource block, and a radio link control buffer size when the communication unit 1210 transmits data via the first communication module for communication with a mobile communication network. The memory unit 1230 may store information on at least one of a maximum aggregation size and a media access control (MAC) buffer size when the communication unit 1210 transmits data via the second communication module for communication with a wireless LAN.

The controller 1240 may include various processing/control circuitry and control overall operations of a control device. For example, the controller 1240 performs processing and control for communication of data including a TCP ACK transmitted to a server. The controller 1240 may include at least one processor which may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The controller 1240 according to various embodiments of the disclosure may determine, based on network information, a maximum size of transmittable data, and determine a transmission rate of each of the multiple TCP connections, based on a size of transmittable data. The controller 1240 may determine the transmission rate of each of the multiple TCP connections, based on at least one of the number of the multiple TCP connections, weight information of a service used by each of the multiple TCP connections, and a data transmission amount used by each of the multiple TCP connections.

The controller 1240 may determine the transmission rate of each of the multiple TCP connections by distributing the determined maximum size of transmittable data to each of the multiple TCP connections.

The structure of the UE 1200 illustrated in FIG. 12 is a merely an example of the UE, and examples of the UE for performing various embodiment of the disclosure are not limited to the structure illustrated in FIG. 12. For example, various elements may be added, omitted, or changed according to various embodiments.

Various embodiments of the disclosure are merely examples that have been presented to easily explain the technical contents of embodiments of the disclosure and help understanding of embodiments of the disclosure, and are not intended to limit the scope of the disclosure. It will be apparent to those skilled in the art that other variants based on the technical idea of the disclosure may be implemented. The above respective embodiments may be employed in combination, as necessary.

As described above, a method performed by a base station in a wireless communication system according to various example embodiments of the disclosure may include: if a packet data control protocol (PDCP) service data unit (SDU) is unable to be transferred from a PDCP layer to a lower layer, storing the PDCP SDU in a buffer; if a size of the PDCP SDU stored in the buffer is equal to or greater than a preconfigured threshold capacity, including information indicating a transmission control protocol (TCP) congestion situation in a field within a header of a first TCP acknowledgement (ACK) transmitted by a UE to a server; transmitting, to the server, a second TCP ACK including the information indicating the TCP congestion situation; and receiving, from the server, a TCP packet including information indicating that the TCP congestion situation has been confirmed.

According to various example embodiments of the disclosure, the including of the information indicating the TCP congestion situation in the field within the header of the first TCP ACK may further include recalculating a TCP checksum value based on the information indicating the TCP congestion situation.

According to various example embodiments of the disclosure, the second TCP ACK may include the information indicating the TCP congestion situation in the first TCP ACK.

According to various example embodiments of the disclosure, the information indicating that the TCP congestion situation has been confirmed may be included in a congestion window reduced (CWR) field within a TCP header of the TCP packet.

According to various example embodiments of the disclosure, the method may further include, based on the CWR field within the TCP header of the TCP packet received from the server, stopping the including of the information indicating the TCP congestion situation in the field within the header of the first TCP ACK.

According to various example embodiments of the disclosure, the method may further include transferring, to the UE, the packet which has been received from the server and includes the information indicating that the TCP congestion situation has been confirmed.

According to various example embodiments of the disclosure, the information indicating the TCP congestion situation may be included in a TCP ECN-echo (ECE) field inducing a TCP congestion situation control within a header of the second TCP ACK.

According to various example embodiments of the disclosure, the lower layer may include a radio link control (RLC) layer.

As described above, a device of a base station in a wireless communication system according to various example embodiments of the disclosure may include: a communication unit comprising communication circuitry, and at least one processor, comprising processing circuitry, wherein at least one processor, individually and/or collectively, is configured to cause the device to: if a packet data control protocol (PDCP) service data unit (SDU) is unable to be transferred from a PDCP layer to a lower layer, store the PDCP SDU in a buffer; if a size of the PDCP SDU stored in the buffer is equal to or greater than a preconfigured threshold capacity, include information indicating a transmission control protocol (TCP) congestion situation in a field within a header of a first TCP acknowledgement (ACK) transmitted by a terminal to a server; transmit, to the server, a second TCP ACK including the information indicating the TCP congestion situation; and receive, from the server, a TCP packet including information indicating that the TCP congestion situation has been confirmed.

According to various example embodiments of the disclosure, at least one processor, individually and/or collectively, may be configured to recalculate a TCP checksum value based on the information indicating the TCP congestion situation.

According to various example embodiments of the disclosure, the second TCP ACK may include the information indicating the TCP congestion situation in the first TCP ACK.

According to various example embodiments of the disclosure, the information indicating that the TCP congestion situation has been confirmed may be included in a congestion window reduced (CWR) field within a TCP header of the TCP packet.

According to various example embodiments of the disclosure, at least one processor, individually and/or collectively, may be configured to, based on the CWR field within the TCP header of the TCP packet received from the server, stop the including of the information indicating the TCP congestion situation in the field within the header of the first TCP ACK.

According to various example embodiments of the disclosure, at least one processor, individually and/or collectively, may be configured to to transfer, to the UE, the packet which has been received from the server and includes the information indicating that the TCP congestion situation has been confirmed.

According to various example embodiments of the disclosure, the information indicating the TCP congestion situation may be included in a TCP ECN-echo (ECE) field inducing a TCP congestion situation control within a header of the second TCP ACK.

What is claimed is:

1. A method performed by a base station in a wireless communication system, the method comprising:
in case that a packet data control protocol (PDCP) service data unit (SDU) is unable to be transferred from a PDCP layer to a lower layer, storing the PDCP SDU in a buffer:
in case that a size of the PDCP SDU stored in the buffer is equal to or greater than a preconfigured threshold capacity, including information indicating a transmission control protocol (TCP) congestion situation in a field within a header of a first TCP acknowledgement (ACK) transmitted by a terminal to a server;
transmitting, to the server, a second TCP ACK comprising the information indicating the TCP congestion situation; and
receiving, from the server, a TCP packet comprising information indicating that the TCP congestion situation has been confirmed.

2. The method of claim 1, wherein the including of the information indicating the TCP congestion situation in the field within the header of the first TCP ACK further comprises:
recalculating a TCP checksum value, based on the information indicating the TCP congestion situation.

3. The method of claim 1, wherein the second TCP ACK comprises the information indicating the TCP congestion situation in the first TCP ACK.

4. The method of claim 1, wherein the information indicating that the TCP congestion situation has been confirmed is included in a congestion window reduced (CWR) field within a TCP header of the TCP packet.

5. The method of claim 4, further comprising, based on the CWR field within the TCP header of the TCP packet received from the server, stopping the including of the information indicating the TCP congestion situation in the field within the header of the first TCP ACK.

6. The method of claim 1, further comprising transferring, to the terminal, the packet received from the server and including the information indicating that the TCP congestion situation has been confirmed.

7. The method of claim 1, wherein the information indicating the TCP congestion situation is included in a TCP ECN-echo (ECE) field inducing a TCP congestion situation control within a header of the second TCP ACK.

8. The method of claim 1, wherein the lower layer comprises a radio link control (RLC) layer.

9. A device of a base station in a wireless communication system, the device comprising:
a communication unit comprising communication circuitry; and
at least one processor, comprising processing circuitry;
wherein at least one processor is configured to perform control to:
in case that a packet data control protocol (PDCP) service data unit (SDU) is unable to be transferred from a PDCP layer to a lower layer, store the PDCP SDU in a buffer;
in case that a size of the PDCP SDU stored in the buffer is equal to or greater than a preconfigured threshold capacity, include information indicating a transmission control protocol (TCP) congestion situation in a field within a header of a first TCP acknowledgement (ACK) transmitted by a terminal to a server;
transmit, to the server, a second TCP ACK comprising the information indicating the TCP congestion situation; and
receive, from the server, a TCP packet comprising information indicating that the TCP congestion situation has been confirmed.

10. The device of claim 9, wherein at least one processor, is configured to:
perform control to recalculate a TCP checksum value, based on the information indicating the TCP congestion situation.

11. The device of claim 9, wherein the second TCP ACK comprises the information indicating the TCP congestion situation in the first TCP ACK.

12. The device of claim 9, wherein the information indicating that the TCP congestion situation has been confirmed is included in a congestion window reduced (CWR) field within a TCP header of the TCP packet.

13. The device of claim 12, wherein the at least one processor is configured to perform control to, based on the CWR field within the TCP header of the TCP packet received from the server, stop the including of the information indicating the TCP congestion situation in the field within the header of the first TCP ACK.

14. The device of claim 9, wherein the at least one processor is configured to perform control to transfer, to the terminal, the packet received from the server and including the information indicating that the TCP congestion situation has been confirmed.

15. The device of claim 9, wherein the information indicating the TCP congestion situation is included in a TCP ECN-echo (ECE) field inducing a TCP congestion situation control within a header of the second TCP ACK.

16. The device of claim 9, wherein the lower layer comprises a radio link control (RLC) layer.
